(19) United States
(12) Patent Application Publication
(10) Pub. No.: US 2013/0087252 A1
(43) Pub. Date: Apr. 11, 2013

(54) HIGH-STRENGTH HOT-ROLLED STEEL SHEET HAVING EXCELLENT FORMABILITY AND METHOD FOR MANUFACTURING THE SAME

(71) Applicants: Tamako Ariga, Tokyo (JP); Katsumi Nakajima, Tokyo (JP); Yoshimasa Funakawa, Tokyo (JP); Noriaki Moriyasu, Tokyo (JP); Takayuki Murata, Tokyo (JP)

(72) Inventors: Tamako Ariga, Tokyo (JP); Katsumi Nakajima, Tokyo (JP); Yoshimasa Funakawa, Tokyo (JP); Noriaki Moriyasu, Tokyo (JP); Takayuki Murata, Tokyo (JP)

(73) Assignee: JFE STEEL CORPORATION, Tokyo (JP)

(21) Appl. No.: 13/704,260

(22) PCT Filed: Jun. 24, 2011
(86) PCT No.: PCT/JP2011/065134

§ 371 Date: Dec. 14, 2012

(30) Foreign Application Priority Data
Jun. 25, 2010 (JP) 2010-145378
Jun. 23, 2011 (JP) 2011-139036

(51) Int. Cl. C21D 8/02; C22C 38/00; C22C 38/02; C22C 38/04; C22C 38/10; C22C 38/16; C22C 38/18; C22C 38/08; C22C 38/12; B32B 15/01; C22C 38/14

(52) U.S. Cl. CPC C21D 8/0205; B32B 15/01; C22C 38/001; C22C 38/004; C22C 38/02; C22C 38/04; C22C 38/14; C22C 38/16; C22C 38/18; C22C 38/08; C22C 38/008; C22C 38/12; C22C 38/10; C22C 38/002
USPC 148/507; 148/320; 148/330; 148/332; 148/333; 148/336

(57) ABSTRACT

A high-strength hot-rolled steel sheet has a composition including C: 0.005% or more and 0.050% or less, Si: 0.2% or less, Mn: 0.8% or less, P: 0.025% or less, S: 0.01% or less, N: 0.01% or less, Al: 0.06% or less, and Ti: 0.05% or more and 0.10% or less, on a mass percent basis, such that S, N, and Ti satisfy Ti≧0.04+(N/14×48+S/32×48), the remainder being Fe and incidental impurities; a matrix in which a ferrite phase constitutes 95% by area or more of the entire structure; and a structure in which Ti-containing fine carbide having an average grain size of less than 10 nm is dispersedly precipitated, and the volume ratio of the fine carbide to the entire structure is 0.0007 or more.

### RELATED APPLICATIONS

This is a §371 of International Application No. PCT/JP2011/065134, with an international filing date of Jun. 24, 2011 (WO 2011/162418 A1, published Dec. 29, 2011), which is based on Japanese Patent Application Nos. 2010-145378, filed Jun. 25, 2010, and 2011-139036, filed Jun. 23, 2011, the subject matter of which is incorporated herein by reference.

### TECHNICAL FIELD

This disclosure relates to a high-strength hot-rolled steel sheet having excellent formability (stretch flange formability) suitable as a material for transportation machinery such as automotive parts or a structural material, and a method for manufacturing the high-strength hot-rolled steel sheet.

### BACKGROUND

To decrease CO₂ emissions from the perspective of global environmental conservation, it is always important in the automobile industry to decrease the weight of automotive bodies while maintaining their strength and improve mileage. To decrease the weight of automotive bodies while maintaining their strength, it is effective to increase the strength of steel sheets serving as materials for automotive parts to decrease the thickness of the steel sheets. For example, an increase in the strength and a decrease in the thickness of steel sheets for automotive suspension parts result in a significant decrease in automobile weight and are therefore effective for improving mileage. Thus, there is a very high demand for higher-strength materials for these parts.

Most of automotive parts made of steel sheets are shaped by press forming or burring. Thus, steel sheets for automotive parts must have excellent elongation and stretch flange formability. For example, strength and formability are regarded as important in steel sheets serving as materials for suspension parts, which have complicated shapes. Thus, there is a demand for a high-strength steel sheet having excellent elongation and formability such as stretch flange formability.

However, steel materials having higher strength generally have lower formability. Thus, to use high-strength hot-rolled steel sheets in suspension parts, it is necessary to develop high-strength hot-rolled steel sheets having high strength and formability. Many studies have been done and various techniques have been proposed.

For example, Japanese Unexamined Patent Application Publication No. 4-329848 proposes a technique for improving the fatigue characteristics and stretch flange formability of a high-strength hot-rolled steel sheet having a tensile strength (TS) of more than 490 N/mm² (490 MPa). The high-strength hot-rolled steel sheet has a composition of C, 0.03% to 0.25%, Si: 2.0% or less, Mn: 2.0% or less, P: 0.1% or less, S: 0.007% or less, Al: 0.07% or less, and Cr: 1.0% or less, on a weight percent basis, and a complex structure of ferrite and a second phase (at least one of pearlite, bainite, martensite, and retained austenite). The hardness, volume percentage, and grain size of the second phase are limited.

Japanese Unexamined Patent Application Publication No. 2000-328186 proposes a technique for improving the fatigue strength, particularly stretch flange formability, of a high-strength hot-rolled steel sheet having a tensile strength (TS) of 490 MPa or more. The high-strength hot-rolled steel sheet contains chemical components of C, 0.01% to 0.10%, Si: 1.5% or less, Mn: more than 1.0% to 2.5%, P: 0.15% or less, S: 0.008% or less, Al: 0.01% to 0.08%, and one or two of Ti and Nb: 0.10% to 0.60%, on a weight percent basis, and ferrite constitutes 95% by area or more. The ferrite has an average grain size in the range of 2.0 to 10.0 μm. The high-strength hot-rolled steel sheet does not contain martensite or retained austenite. In the technique proposed by JP '186, the Mn content is more than 1.0% to 2.5% so as to improve the strength of the steel sheet and prepare fine ferrite grains.

Japanese Unexamined Patent Application Publication No. 2002-161340 proposes a technique for improving the burring and fatigue characteristics of a high-strength hot-rolled steel sheet having a tensile strength (TS) of 640 MPa or more. The high-strength hot-rolled steel sheet has a composition of C, 0.01% to 0.1%, S≦0.03%, N≦0.005%, Ti: 0.05% to 0.5%, Si: 0.01% to 2%, Mn: 0.05% to 2%, P≦0.1%, Al: 0.005% to 1.0%, and Ti satisfying Ti-48/12C-48/14N-48/32S≧0%, on a mass percent basis. A precipitate containing Ti grains of 5 nm or more in steel has an average size in the range of 10¹ to 10³ nm and minimum intervals in the range of more than 10¹ nm and 10⁴ nm or less.

However, according to the technique proposed by JP '848, in the press forming of the steel sheet into parts having a desired shape, the interface between the soft ferrite and hard second phase is likely to act as a starting point of cracking during forming, resulting in unstable formability. Furthermore, according to the technique proposed by JP '848, when the tensile strength (TS) of the steel sheet is increased to approximately 590 MPa, formability, particularly stretch flange formability, cannot satisfy the present requirements (see examples in JP '848).

According to the technique proposed by JP '186, the high Mn content of the steel sheet results in segregation of Mn in the central portion in the thickness direction, which induces cracking in the press forming of the steel sheet. Thus, it is difficult to consistently achieve excellent stretch flange formability, and it is not necessarily possible to achieve sufficient stretch flange formability. Furthermore, according to the technique proposed by JP '186, the Ti content is predetermined to form Ti carbide to decrease C solid solution, which adversely affects stretch flange formability. However, an excessive amount of Ti relative to C is likely to result in the coarsening of Ti carbide, making it impossible to stably achieve desired strength.

According to the technique proposed by JP '340, the precipitate in the steel sheet has large size distribution, and it is impossible to consistently achieve desired strength. Furthermore, according to the technique proposed by JP '340, the steel sheet has insufficient stretch flange formability (see examples of JP '340).

To stably supply materials for mass-produced automotive parts, hot-rolled steel sheets must be industrially mass-produced. According to the publications described above, it is difficult to stably supply a high-strength hot-rolled steel sheet having a tensile strength (TS) of 590 MPa or more and excellent formability (stretch flange formability).

It could therefore be helpful to provide a high-strength hot-rolled steel sheet that is a suitable material for automotive parts and has a tensile strength (TS) of 590 MPa or more and excellent formability (stretch flange formability), more specifically, a hole expanding ratio λ of 100% or more, and a method for manufacturing the high-strength hot-rolled steel sheet.

### SUMMARY

We discovered:
1) When the steel sheet structure is a ferrite single phase structure having a low dislocation density and excellent formability and subjected to precipitation hardening through dispersed precipitation of fine carbide, the hot-rolled steel sheet can have improved strength while maintaining stretch flange formability.
2) The manufacture of a hot-rolled steel sheet having excellent formability and a high tensile strength (TS) of 590 MPa or more requires dispersed precipitation of fine carbide in a desired volume ratio. The fine carbide has an average grain size of less than 10 nm that is effective for precipitation hardening.
3) As fine carbide contributing to precipitation hardening, Ti-containing carbide is effective in terms of high strength.
4) The dispersed precipitation of Ti-containing carbide having an average grain size of less than 10 nm in a desired volume ratio requires a certain amount of Ti for forming Ti carbide, which serves as a precipitation nucleus, and at least a predetermined amount of Ti relative to the N and S contents of the steel material (Ti≧0.04+(N/14×48+S/32×48)) must be contained.
5) To precipitate fine Ti-containing carbide (having an average grain size of less than 10 nm) in a ferrite phase, it is effective to adjust the B content and the Mn content of the steel material to a desired ratio (B≧0.001×Mn).

6) When the Ti content of Ti-containing carbide is higher than the C content on the basis of the atomic ratio, the carbide is likely to become coarse and adversely affects the characteristics of the hot-rolled steel sheet.

7) To make the Ti content of Ti-containing carbide lower than the C content on the basis of atomic ratio to prevent the coarsening of carbide, it is effective to control the Ti, N, and S contents relative to the C content in the steel material in a predetermined range (C/12>Ti/48-N/14-S/32).

We thus provide:
[1] A high-strength hot-rolled steel sheet having excellent formability, including: a composition including
   C, 0.005% or more and 0.050% or less, Si: 0.2% or less,
   Mn: 0.8% or less, P: 0.025% or less,
   S: 0.01% or less, N: 0.01% or less,
   Al: 0.06% or less, and Ti: 0.05% or more and 0.10% or less, on a mass percent basis, such that S, N, and Ti satisfy Formula (1), the remainder being Fe and incidental impurities; a matrix in which a ferrite phase constitutes 95% by area or more of the entire structure; and a structure in which Ti-containing fine carbide having an average grain size of less than 10 nm is dispersedly precipitated, and the volume ratio of the fine carbide to the entire structure is 0.0007 or more, wherein the high-strength hot-rolled steel sheet has a tensile strength of 590 MPa or more:

Ti≧0.04+(N/14×48+S/32×48) (1)
wherein S, N, and Ti denote their respective contents (% by mass).
[2] The high-strength hot-rolled steel sheet having excellent formability according to [1], further containing B: 0.0003% or more and 0.0035% or less on a mass percent basis so as to satisfy Formula (2):

B≧0.001×Mn (2)
wherein Mn and B denote their respective contents (% by mass).
[3] The high-strength hot-rolled steel sheet having excellent formability according to [1] or [2], wherein the composition satisfies Formula (4):

C/12>Ti/48−N/14−S/32 (4)
wherein C, S, N, and Ti denote their respective contents (% by mass).
[4] The high-strength hot-rolled steel sheet having excellent formability according to any one of [1] to [3], wherein the atomic ratio of C to Ti in the fine carbide satisfies Formula (3):

C/Ti>1.0 (3)
wherein C/Ti denotes the atomic ratio of C to Ti in the fine carbide.
[5] The high-strength hot-rolled steel sheet having excellent formability according to any one of [1] to [4], further containing at least one of Cu, Sn, Ni, Ca, Mg, Co, As, Cr, W, Nb, Pb, and Ta, which in total constitutes 0.1% or less of the composition on a mass percent basis.
[6] The high-strength hot-rolled steel sheet having excellent formability according to any one of [1] to [5], further including a plating film on the surface thereof
[7] A method for manufacturing a high-strength hot-rolled steel sheet having a tensile strength of 590 MPa or more and excellent formability, including:
   hot rolling steel, the hot rolling involving rough rolling and finish rolling; and then cooling and coiling the steel to manufacture a hot-rolled steel sheet,
   wherein the steel has a composition including
   C: 0.005% or more and 0.050% or less, Si: 0.2% or less,
   Mn: 0.8% or less, P: 0.025% or less,
   S: 0.01% or less, N: 0.01% or less,
   Al: 0.06% or less, and Ti: 0.05% or more and 0.10% or less, on a mass percent basis, such that S, N, and Ti satisfy Formula (1), the remainder being Fe and incidental impurities,
   the finish-rolling temperature is 880° C. or more, the average cooling rate is 10° C./s or more, and the coiling temperature is 550° C. or more and less than 800° C.:

Ti≧0.04+(N/14×48+S/32×48) (1)
wherein S, N, and Ti denote their respective contents (% by mass).
[8] The method for manufacturing a high-strength hot-rolled steel sheet having excellent formability according to [7], further containing B: 0.0003% or more and 0.0035% or less on a mass percent basis so as to satisfy Formula (2):

B≧0.001×Mn (2)
wherein Mn and B denote their respective contents (% by mass).
[9] The method for manufacturing a high-strength hot-rolled steel sheet having excellent formability according to [7] or [8], wherein the composition satisfies Formula (4):

C/12>Ti/48−N/14−S/32 (4)
wherein C, S, N, and Ti denote their respective contents (% by mass).
[10] The method for manufacturing a high-strength hot-rolled steel sheet having excellent formability according to any one of [7] to [9], further comprising at least one of Cu, Sn, Ni, Ca, Mg, Co, As, Cr, W, Nb, Pb, and Ta, which in total constitutes 0.1% or less of the composition on a mass percent basis.

We provide a high-strength hot-rolled steel sheet that has a tensile strength (TS) of 590 MPa or more suitable for automotive steel sheets and excellent formability (stretch flange formability) as a material satisfactorily applicable to suspension parts having a complicated cross-sectional shape in press forming.

### DETAILED DESCRIPTION

Our steel sheets and methods will be described in detail below.

The following are reasons for defining the structure and carbide of our steel sheets.

A hot-rolled steel sheet includes a matrix in which a ferrite phase constitutes 95% by area or more of the entire structure and a structure in which Ti-containing fine carbide having an average grain size of less than 10 nm is dispersedly precipitated in the matrix, and the volume ratio of the fine carbide to the entire structure is 0.0007 or more.

Ferrite phase: 95% by area or more of the entire structure

The ferrite phase must be formed to improve formability (stretch flange formability) of a hot-rolled steel sheet. To improve the elongation and stretch flange formability of a hot-rolled steel sheet, the structure of the hot-rolled steel sheet is effectively a ferrite phase having a low dislocation density and excellent ductility. In particular, to improve stretch flange formability, the structure of the hot-rolled steel sheet is preferably a ferrite single phase structure. Even in the case of an incomplete ferrite single phase structure, a substantial ferrite single phase structure, more specifically, a ferrite phase constituting 95% by area or more of the entire structure has the advantages described above. Thus, the ferrite phase constitutes 95% by area or more, preferably 97% by area or more, of the entire structure.

In our hot-rolled steel sheet, examples of a structure other than the ferrite phase include cementite, pearlite, a bainite phase, a martensite phase, and a retained austenite phase. Such structures in total may constitute approximately 5% by area or less, preferably approximately 3% by area or less, of the entire structure.

Ti-containing fine carbide

Ti-containing carbide is highly likely to be fine carbide having a very small average grain size. Thus, we cause dispersed precipitation of fine carbide in a hot-rolled steel sheet to increase the strength of the hot-rolled steel sheet, the fine carbide to be dispersedly precipitated is Ti-containing fine carbide. As described below, the atomic ratio of C to Ti in the fine carbide preferably satisfies a predetermined condition.

Average grain size of fine carbide: less than 10 nm

To impart desired strength (tensile strength: 590 MPa or more) to a hot-rolled steel sheet, the average grain size of fine carbide is very important. Ti-containing fine carbide has an average grain size of less than 10 nm. Fine carbide precipitated in a matrix acts as resistance to dislocation movement during deformation of a hot-rolled steel sheet, thus strengthening the steel sheet. Fine carbide having an average grain size of less than 10 nm more strongly exerts this effect. Thus, Ti-containing fine carbide has an average grain size of less than 10 nm, preferably 5 nm or less.

Volume ratio of fine carbide to the entire structure: 0.0007 or more

To impart desired strength (tensile strength: 590 MPa or more) to a hot-rolled steel sheet, the dispersed precipitation state of Ti-containing fine carbide is also very important. Ti-containing fine carbide having an average grain size of less than 10 nm is dispersedly precipitated such that the volume ratio of the Ti-containing fine carbide to the entire structure is 0.0007 or more. Even when Ti-containing fine carbide has an average grain size of less than 10 nm, a volume ratio of less than 0.0007 results in difficulty in achieving the desired strength (tensile strength: 590 MPa or more) of a hot-rolled steel sheet because of a decreased amount of fine carbide. Thus, the volume ratio is 0.0007 or more. However, a volume ratio of more than 0.004 results in excessively high strength, which may result in poor stretch flange formability. Thus, the volume ratio is preferably 0.0007 or more and 0.004 or less.

Although the main precipitation form of Ti-containing fine carbide is linear precipitation, the presence of randomly precipitated fine carbide has no effects on the characteristics. Irrespective of the precipitation form, therefore, such precipitation forms are collectively referred to as dispersed precipitation.

The following are reasons for defining the composition of a hot-rolled steel sheet. Unless otherwise specified, % of the components refers to % by mass.

C: 0.005% or more and 0.050% or less

C is an essential element in terms of the formation of fine carbide and strengthening of the hot-rolled steel sheet. A C content of less than 0.005% results in fine carbide not having the desired volume ratio and a tensile strength of less than 590 MPa. On the other hand, a C content of more than 0.050% results in increased strength, an increased likelihood of formation of pearlite in the steel sheet, and increased difficulties in achieving excellent stretch flange formability. Thus, the C content is 0.005% or more and 0.050% or less, preferably 0.020% or more and 0.035% or less, more preferably 0.020% or more and 0.030% or less.

Si: 0.2% or less

Si is a solid-solution strengthening element and effective in increasing the strength of steel. However, a Si content of more than 0.2% results in promotion of C precipitation from a ferrite phase, an increased likelihood of precipitation of coarse Fe carbide at grain boundaries, and poor stretch flange formability. Excessive Si adversely affects platability. Thus, the Si content is 0.2% or less, preferably 0.05% or less.

Mn: 0.8% or less

Mn is a solid-solution strengthening element and effective in increasing the strength of steel. It is therefore desirable that the Mn content be increased to strengthen the hot-rolled steel sheet. However, a Mn content of more than 0.8% results in an increased likelihood of segregation, formation of a phase other than the ferrite phase, that is, a hard phase, and poor stretch flange formability. Thus, the Mn content is 0.8% or less, preferably 0.35% or less, more preferably 0.3% or less.

P: 0.025% or less

P is a solid-solution strengthening element and effective in increasing the strength of steel. However, a P content of more than 0.025% results in an increased likelihood of segregation and poor stretch flange formability. Thus, the P content is 0.025% or less, preferably 0.02% or less.

S: 0.01% or less

S causes deterioration in hot workability (hot rollability), increases susceptibility to hot tearing of a slab, and exists in steel as MnS which causes deterioration in the stretch flange formability of the hot-rolled steel sheet. Thus, S is preferably minimized and is 0.01% or less, preferably 0.005% or less.

N: 0.01% or less

N is a harmful element and preferably minimized. In particular, an N content of more than 0.01% results in formation of coarse nitride in steel which causes deterioration in stretch flange formability. Thus, the N content is 0.01% or less, preferably 0.006% or less.

Al: 0.06% or less

Al acts as a deoxidizer. It is desirable that Al constitute 0.001% or more to produce such an effect. However, Al constituting more than 0.06% results in poor elongation and stretch flange formability. Thus, the Al content is 0.06% or less.

Ti: 0.05% or more and 0.10% or less

Ti is the most important element. Ti forms carbide and thereby contributes to increased strength of the steel sheet while maintaining excellent stretch flange formability. At a Ti content of less than 0.05%, it is impossible to achieve the desired strength (tensile strength of 590 MPa or more) of the hot-rolled steel sheet. On the other hand, a Ti content of more than 0.10% may result in poor stretch flange formability. Thus, the Ti content is 0.05% or more and 0.10% or less, preferably 0.065% or more and 0.095% or less.

Our hot-rolled steel sheet contains S, N, and Ti in the range described above to satisfy Formula (1):

Ti≧0.04+(N/14×48+S/32×48) (1)

wherein S, N, and Ti denote their respective contents (% by mass).

Formula (1) is a requirement to be satisfied so that Ti-containing fine carbide has the desired precipitation state described above and is a very important indicator.

Ti≧0.04+(N/14×48+S/32×48) (1)

As described above, we cause dispersed precipitation of Ti-containing fine carbide in a hot-rolled steel sheet. Carbide in steel is dissolved by heating before hot rolling and precipitated during the coiling process after the hot rolling. To stably precipitate fine carbide having an average grain size of less than 10 nm and perform dispersed precipitation such that the volume ratio of the fine carbide to the entire structure is 0.0007 or more, a sufficient amount of Ti serving as precipitation nuclei of fine carbide must be contained. In a high-temperature region, however, Ti tends to form nitride or sulfide rather than carbide. Thus, with precipitation of nitride or sulfide, an insufficient Ti content relative to the N and S contents in steel results in a decreased amount of Ti serving as precipitation nuclei of fine carbide. It is therefore difficult to precipitate Ti-containing fine carbide at the desired volume ratio (0.0007 or more).

Thus, the Ti, N, and S contents are controlled to satisfy Formula (1): Ti≧0.04+(N/14×48+S/32×48). This ensures a sufficient amount of Ti serving as precipitation nuclei of fine carbide, allows fine carbide having an average grain size of less than 10 nm to be stably precipitated, and allows dispersed precipitation to occur such that the volume ratio of the fine carbide to the entire structure is 0.0007 or more.

Steel is heated to an austenite region before hot rolling to dissolve carbide in the steel and, simultaneously, with subsequent austenite to ferrite transformation, Ti-containing carbide is precipitated. However, a high austenite to ferrite transformation temperature results in coarse precipitated Ti-containing carbide. Thus, the austenite to ferrite transformation temperature (Ar₃ transformation point) is preferably controlled in the coiling temperature range such that Ti-containing carbide is precipitated during the coiling process. This can prevent coarsening, resulting in the formation of carbide having an average grain size of less than 10 nm.

To control the austenite to ferrite transformation temperature (Ar₃ transformation point) in the coiling temperature, in addition to the components described above, B: 0.0003% or more and 0.0035% or less is preferably contained so as to satisfy Formula (2):

B≧0.001×Mn (2).

B: 0.0003% or more and 0.0035% or less

B can reduce the Ar₃ transformation point of steel. B is added to reduce the Ar₃ transformation point of steel and can thereby reduce the size of Ti-containing carbide. A B content of less than 0.0003% results in an insufficiently decreased Ar₃ transformation point and an insufficient effect of reducing the size of Ti-containing carbide. The effect levels off at a B content of more than 0.0035%. Thus, the B content is preferably 0.0003% or more and 0.0035% or less, more preferably 0.0005% or more and 0.0020% or less.

B≧0.001×Mn (2)

When B is contained, it is also important to appropriately control the ratio of the B content to the Mn content in steel. We studied the dispersed precipitation of fine Ti-containing carbide (having an average grain size of less than 10 nm) in a matrix in which a ferrite phase constitutes 95% by area or more of the entire structure. As a result, found that, to obtain Ti-containing carbide having an average grain size of less than 10 nm, it is effective to control the austenite to ferrite transformation temperature (Ar₃ transformation point) in the hot rolling process in a coiling temperature range described below.

As a result of further investigation, we found that the Ar₃ transformation point of steel can be controlled in a desired range by controlling a steel composition to satisfy a desired relationship between the B content and the Mn content of the steel. B of less than (0.001×Mn) results in a high Ar₃ transformation point of steel and an insufficiently reduced size of Ti-containing carbide. Thus, in the presence of B, B≧0.001×Mn.

When the percentage of the solid-solution strengthening element Mn is more than 0.35%, the desired strength (tensile strength: 590 MPa or more) of a steel sheet can be achieved without the effect of B. However, when the Mn content is 0.35% or less, it may be difficult to achieve the desired strength of a steel sheet without the effect of B. Thus, when the Mn content is 0.35% or less, B is preferably contained so as to reduce the size of Ti-containing carbide.

The C, S, N, and Ti contents are preferably controlled in the range described above to satisfy Formula (4):

C/12>Ti/48−N/14−S/32 (4)

wherein C, S, N, and Ti denote their respective contents (% by mass).

As described above, Ti-containing carbide is highly likely to be fine carbide having a very small average grain size. However, when Ti to be bound to C is greater than or equal to C on the basis of the atomic ratio, carbide is likely to become coarse. With the coarsening of carbide, precipitation hardening due to carbide decreases, and it becomes difficult to achieve the desired strength (tensile strength: 590 MPa or more) of the hot-rolled steel sheet.

Thus, the C, Ti, N, and S contents preferably satisfy Formula (4). More specifically, with respect to C and Ti in the steel, the atomic % of C(C/12) is preferably higher than the atomic % of Ti involved in formation of carbide (Ti/48-N/14-S/32). This can prevent the coarsening of Ti-containing fine carbide.

Instead of the C, Ti, N, and S contents satisfying Formula (4), the atomic ratio of C to Ti in Ti-containing fine carbide may satisfy Formula (3):

C/Ti>1.0 (3)

wherein C/Ti denotes the atomic ratio of C to Ti in the fine carbide.

The plausible reason for the coarsening of carbide when Ti in carbide is greater than or equal to C is that the coarsening of carbide depends on diffusion of Ti which is slow in diffusion.

Our steel sheet may contain at least one of Cu, Sn, Ni, Ca, Mg, Co, As, Cr, W, Nb, Pb, and Ta, which in total constitutes 0.1% or less, preferably 0.03% or less. The remainder components are Fe and incidental impurities.

Our steel sheet may have a plating film on the surface thereof. The plating film on the surface of the steel sheet improves the corrosion resistance of the hot-rolled steel sheet. Thus, the hot-rolled steel sheet is suitable as a material for parts to be exposed to severe corrosive environment, for example, automotive suspension parts. Examples of the plating film include galvanizing films and galvannealing films.

A method for manufacturing a hot-rolled steel sheet will be described below.

The method involves hot rolling steel, the hot rolling including rough rolling and finish rolling, and then cooling and coiling the steel to manufacture a hot-rolled steel sheet. The finish-rolling temperature is 880° C. or more, the average cooling rate is 10° C./s or more, and the coiling temperature is 550° C. or more and less than 800° C.

A method for melting steel is not particularly limited and may be a known melting method using a converter, an electric furnace, or the like. After the melting process, in consideration of segregation and another problem, a slab (steel) is preferably produced by a continuous casting process. A slab may also be produced by a known casting process such as an ingot making and blooming process or a thin slab continuous casting process. When the slab is hot-rolled after casting, the slab may be reheated in a furnace before rolling or, if the slab has a predetermined temperature or more, may be directly hot-rolled without heating the slab.

The steel thus produced is subjected to rough rolling and finish rolling. Carbide in the steel must be dissolved before rough rolling. In the method, which includes a carbide-forming element Ti, the heating temperature of the steel is preferably 1150° C. or more. An excessively high heating temperature of the steel results in excessive oxidation of the surface and the formation of TiO₂, which consumes Ti. This often results in lower hardness in the vicinity of the surface of the resulting steel sheet. Thus, the heating temperature is preferably 1300° C. or less. As described above, when the steel before rough rolling has a predetermined temperature or more and when carbide in the steel is dissolved, the steel is not necessarily heated before rough rolling. The rough rolling conditions are not particularly limited.

Finish-rolling temperature: 880° C. or more

Controlling the finish-rolling temperature is important in improving elongation and stretch flange formability of a hot-rolled steel sheet and reducing the rolling load of finish rolling. A finish-rolling temperature of less than 880° C. results in coarsening of crystal grains in the surface layer of the hot-rolled steel sheet and deterioration in stretch flange formability. Furthermore, since rolling is performed in a non-recrystallization temperature range, coarse Ti carbide is precipitated at prior austenite grain boundaries, resulting in poor stretch flange formability. Thus, the finish-rolling temperature is 880° C. or more, preferably 900° C. or more. An excessively high finish-rolling temperature results in the coarsening of crystal grains, which adversely affects the desired strength (tensile strength: 590 MPa or more) of the steel sheet. Thus, the finish-rolling temperature is desirably 1000° C. or less.

Average cooling rate: 10° C./s or more

After finish rolling, when the average cooling rate from 880° C. or more to the coiling temperature is less than 10° C./s, this results in a high Ar₃ transformation point and an insufficiently reduced size of Ti-containing carbide. Thus, the average cooling rate is 10° C./s or more, preferably 30° C./s or more.

Coiling temperature: 550° C. or more and less than 800° C.

Controlling the coiling temperature is very important in achieving the desired structure of the hot-rolled steel sheet throughout the entire width direction of the hot-rolled steel sheet, more specifically, a matrix in which a ferrite phase constitutes 95% by area or more of the entire structure, and a structure in which Ti-containing fine carbide having an average grain size of less than 10 nm is dispersedly precipitated, and the volume ratio of the fine carbide to the entire structure is 0.0007 or more.

A coiling temperature of less than 550° C. results in insufficient precipitation of fine carbide in an end of rolled steel in the width direction which is likely to be in a supercooled state, making it difficult to achieve the desired strength (tensile strength: 590 MPa or more) of the steel sheet. This also causes a problem that running stability on a runout table is difficult to achieve. On the other hand, a coiling temperature of 800° C. or more results in formation of pearlite, making it difficult to provide a matrix in which a ferrite phase constitutes 95% by area or more of the entire structure. Thus, the coiling temperature is 550° C. or more and less than 800° C., preferably 550° C. or more and less than 700° C., more preferably 580° C. or more and less than 700° C.

Thus, to manufacture a high-strength hot-rolled steel sheet that has a tensile strength (TS) of 590 MPa or more and excellent formability (stretch flange formability) as a material applicable to suspension parts having a complicated cross-sectional shape, it is necessary to dispersedly precipitate fine carbide having an average grain size of less than 10 nm at a desired volume ratio (0.0007 or more) throughout the entire width direction of the steel sheet.

The composition is controlled to allow sufficient dispersed precipitation of fine carbide having an average grain size of less than 10 nm by containing at least a predetermined amount of Ti relative to the N and S contents of a steel material for a hot-rolled steel sheet (Ti≧0.04+(N/14×48+S/32×48)) or further containing B and Mn such that the B and Mn contents of the steel material for the hot-rolled steel sheet satisfy the predetermined relationship (B≧0.001×Mn). Thus, without defining strict manufacturing conditions for a hot-rolled steel sheet, our method allows dispersed precipitation of fine carbide having an average grain size of less than 10 nm at the desired volume ratio (0.0007 or more) throughout the entire width direction, thus providing uniform and excellent characteristics (tensile strength and stretch flange formability) throughout the entire width direction of the hot-rolled steel sheet.

The hot-rolled steel sheet thus manufactured may be plated to form a plating film on the surface of the steel sheet. For example, the hot-rolled steel sheet may be subjected to hot-dip galvanizing to form a galvanizing film or further subjected to alloying to form a galvannealing film on the surface of the steel sheet.

### EXAMPLES

### Example 1

Molten steel having a composition listed in Table 1 was continuously casted into a slab (steel) having a thickness of 250 mm by a known method. The slab was heated to 1250° C. and was then subjected to rough rolling and finish rolling at a finish-rolling temperature listed in Table 2. After the finish rolling, the rolled sheet was cooled from 880° C. to the coiling temperature at an average cooling rate listed in Table 2 and was coiled at a coiling temperature listed in Table 2, thus yielding a hot-rolled steel sheet having a thickness of 2.3 mm. A hot-rolled steel sheet (steel No. A, hot-rolling No. 2) was immersed in a galvanizing bath (0.1% Al—Zn) at 480° C. After 45 g/m² of a galvanizing film was formed, the hot-rolled steel sheet was subjected to alloying at 520° C. to yield a galvannealed steel sheet.

TABLE 1

| | Composition (mass %) | | | | | | | | | Formula | Formula | |
|---|---|---|---|---|---|---|---|---|---|---|---|---|
| Steel No. | C | Si | Mn | P | S | N | Al | Ti | B | (1) | (2) | Note |
| A | 0.025 | 0.03 | 0.31 | 0.011 | 0.0030 | 0.0050 | 0.041 | 0.076 | 0.0020 | 0.062 | 0.00031 | Working |
| | | | | | | | | | | | | Example |
| B | 0.023 | 0.01 | 0.28 | 0.010 | 0.0028 | 0.0043 | 0.043 | 0.064 | 0.0015 | 0.059 | 0.00028 | Working |
| | | | | | | | | | | | | Example |
| C | 0.024 | 0.02 | 0.29 | 0.012 | 0.0016 | 0.0050 | 0.044 | 0.072 | 0.0007 | 0.060 | 0.00029 | Working |
| | | | | | | | | | | | | Example |
| D | 0.002 | 0.01 | 0.20 | 0.010 | 0.0008 | 0.0030 | 0.042 | 0.041 | 0.0002 | 0.051 | 0.00020 | Comparative |
| | | | | | | | | | | | | Example |
| E | 0.031 | 0.02 | 0.81 | 0.011 | 0.0027 | 0.0046 | 0.041 | 0.073 | 0.0003 | 0.060 | 0.00081 | Comparative |
| | | | | | | | | | | | | Example |
| F | 0.035 | 0.02 | 0.28 | 0.011 | 0.0024 | 0.0033 | 0.052 | 0.082 | 0.0005 | 0.057 | 0.00028 | Working |
| | | | | | | | | | | | | Example |
| G | 0.028 | 0.03 | 0.29 | 0.012 | 0.0036 | 0.0049 | 0.049 | 0.051 | 0.0006 | 0.062 | 0.00029 | Comparative |
| | | | | | | | | | | | | Example |

Formula (1): 0.04 + (N/14 × 48 + S/32 × 48)
Formula (2): 0.001 × Mn (mass %)

TABLE 2

| | | Manufacturing conditions | | | |
|---|---|---|---|---|---|
| | | for hot-rolled steel sheet | | | |
| | | Finish- | Average | | |
| | | rolling | cooling | Coiling | |
| | Hot- | tempera- | tempera- | tempera- | |
| Steel | rolling | ture | ture | ture | |
| No. | No. | (° C.) | (° C./s) | (° C.) | Note |
| A | 1 | 901 | 20 | 632 | Working Example |
| | 2 | 888 | 25 | 613 | Working Example |
| | 3 | 842 | 30 | 624 | Comparative |
| | | | | | Example |
| | 4 | 902 | 5 | 618 | Comparative |
| | | | | | Example |
| B | 5 | 902 | 20 | 645 | Working Example |
| C | 6 | 897 | 35 | 537 | Comparative |
| | | | | | Example |
| | 7 | 916 | 25 | 627 | Working Example |
| D | 8 | 902 | 20 | 630 | Comparative |
| | | | | | Example |
| E | 9 | 911 | 20 | 625 | Comparative |
| | | | | | Example |
| F | 10 | 914 | 20 | 604 | Working Example |
| G | 11 | 921 | 25 | 623 | Comparative |
| | | | | | Example |

A test specimen was sampled from the hot-rolled steel sheet and subjected to structure observation, a tensile test, and a hole expanding test to determine the area ratio of a ferrite phase, the average grain size and volume ratio of Ti-containing fine carbide, the atomic ratio of C to Ti in the fine carbide, tensile strength, and the hole expanding ratio (stretch flange formability). The test methods were described below.

### (i) Structure Observation

A test specimen was sampled from the hot-rolled steel sheet. A cross section of the test specimen parallel to the rolling direction was mechanically polished and etched with nital. A structure photograph (SEM photograph) taken with a scanning electron microscope (SEM) at a magnification ratio of 3000 was used to determine the ferrite phase, the type of structure other than the ferrite phase, and their area ratios using an image analyzing apparatus.

A thin film prepared from the hot-rolled steel sheet was observed with a transmission electron microscope (TEM) at a magnification ratio of 120000 to 260000 to determine grain size and volume ratio of Ti-containing fine carbide.

The atomic ratio of C to Ti in fine carbide was determined with an energy dispersive X-ray spectrometer (EDX) of TEM.

Each grain size of Ti-containing fine carbide was determined through image processing using circular approximation on the basis of observation of 30 visual fields at a magnification ratio of 260000. The arithmetic mean of the grain sizes was considered to be the average grain size. The area ratio of fine carbide to the entire structure was determined by image analysis from the observation from which the grain sizes were determined. The area ratio was considered to be the volume ratio.

### (ii) Tensile Test

A JIS No. 5 test piece for tensile test (JIS Z 2201) was sampled from the hot-rolled steel sheet such that the tensile direction was perpendicular to the rolling direction, and was subjected to a tensile test in accordance with JIS Z 2241 to measure tensile strength (TS).

(iii) Hole Expanding Test

A test specimen (size: 130 mm×130 mm) was sampled from the hot-rolled steel sheet. A hole having an initial diameter d₀ of 10 mmφ was punched in the test specimen. The test specimen was subjected to a hole expanding test. More specifically, the hole was expanded with a conical punch having a vertex angle of 60 degrees. When a crack passed through the hot-rolled steel sheet (test specimen), the diameter d of the hole was measured. The hole expanding ratio λ (%) was calculated using the following equation:

Hole expanding ratio λ(%)={(d−d₀)/d₀}×100.

Table 3 shows the results.

TABLE 3

| | | | | | | | Mechanical | | |
|---|---|---|---|---|---|---|---|---|---|
| | | Structure of hot-rolled steel sheet | | | | | characteristics of | | |
| | | | | Ti-containing fine carbide | | | hot-rolled steel sheet | | |
| | Hot- | | Area ratio | Average | | | Tensile | Hole | |
| Steel | rolling | | of ferrite | grain | Volume | | strength | expanding | |
| No. | No. | Type *1 | phase (%) *2 | size (nm) | ratio *3 | C/Ti *4 | TS (MPa) | ratio λ (%) | Note |
| A | 1 | F + P | 98 | 4 | 0.0013 | 1.22 | 615 | 132 | Working |
| | | | | | | | | | Example |
| | 2 | F | 100 | 5 | 0.0011 | 1.34 | 603 | 135 | Working |
| | | | | | | | | | Example |
| | 3 | F + B | 99 | 11 | 0.0005 | 0.97 | 574 | 92 | Comparative |
| | | | | | | | | | Example |
| | 4 | F + P | 98 | 15 | 0.0007 | 1.08 | 468 | 131 | Comparative |
| | | | | | | | | | Example |
| B | 5 | F + P | 99 | 4 | 0.0013 | 1.19 | 614 | 137 | Working |
| | | | | | | | | | Example |
| C | 6 | F + B | 92 | 12 | 0.0006 | 0.95 | 568 | 97 | Comparative |
| | | | | | | | | | Example |
| | 7 | F | 100 | 5 | 0.0014 | 1.28 | 618 | 134 | Working |
| | | | | | | | | | Example |
| D | 8 | F + B | 98 | 11 | 0.0002 | 0.42 | 475 | 113 | Comparative |
| | | | | | | | | | Example |
| E | 9 | F + B | 98 | 12 | 0.0005 | 0.98 | 573 | 71 | Comparative |
| | | | | | | | | | Example |
| F | 10 | F + P | 98 | 4 | 0.0012 | 1.01 | 621 | 128 | Working |
| | | | | | | | | | Example |
| G | 11 | F + B | 98 | 3 | 0.0005 | 1.22 | 463 | 131 | Comparative |
| | | | | | | | | | Example |

*1: F denotes ferrite. P denotes pearlite. B denotes bainite.
*2: Area ratio of ferrite phase to the entire structure (%)
*3: Volume ratio of Ti-containing fine carbide to the entire structure
*4: Atomic ratio of C to Ti in Ti-containing fine carbide

The Working Examples are hot-rolled steel sheets having high-strength, that is, tensile strength TS of 590 MPa or more, and excellent stretch flange formability, that is, a hole expanding ratio λ of 100% or more. The Comparative Examples outside our range do not have the predetermined high strength or hole expanding ratio λ.

### Example 2

Molten steel having a composition listed in Table 4 was continuously casted into a slab (steel) having a thickness of 250 mm by a known method. The slab was heated to 1250° C. and then subjected to rough rolling and finish rolling at a finish-rolling temperature listed in Table 5. After the finish rolling, the rolled sheet was cooled from 880° C. to the coiling temperature at an average cooling rate listed in Table 5 and coiled at a coiling temperature listed in Table 5, thus yielding a hot-rolled steel sheet having a thickness of 2.3 mm. Some hot-rolled steel sheets (steel No. H, hot-rolling No. 13, and steel No. I, hot-rolling No. 15) were immersed in a galvanizing bath (0.1% Al—Zn) at 480° C. to form 45 g/m² of a galvanizing film, thus yielding galvanized steel sheets. After formation of a galvanizing film in the same manner as described above, other hot-rolled steel sheets (steel No. J, hot-rolling No. 18, and steel No. K, No. 22) were subjected to alloying at 520° C., yielding galvannealed steel sheets.

TABLE 4

| Steel | Chemical Composition (mass %) | | | | | | | | | | Formula | Formula | Formula | Satisfying | |
|---|---|---|---|---|---|---|---|---|---|---|---|---|---|---|---|
| No. | C | Si | Mn | P | S | N | Al | Ti | B | Others | (1) | (2) | (4) | Formula (4)* | Note |
| H | 0.037 | 0.02 | 0.68 | 0.012 | 0.0031 | 0.0045 | 0.042 | 0.076 | — | — | 0.060 | 0.00068 | 0.00117 | ◯ | Working |
| | | | | | | | | | | | | | | | Example |
| I | 0.045 | 0.02 | 0.32 | 0.011 | 0.0029 | 0.0043 | 0.043 | 0.079 | 0.0017 | Cu: 0.02, | 0.059 | 0.00032 | 0.00125 | ◯ | Working |
| | | | | | | | | | | Ni: 0.01, | | | | | Example |
| | | | | | | | | | | W: 0.01 | | | | | |
| J | 0.039 | 0.01 | 0.29 | 0.011 | 0.0033 | 0.0042 | 0.045 | 0.074 | 0.0008 | — | 0.059 | 0.00029 | 0.00114 | ◯ | Working |
| | | | | | | | | | | | | | | | Example |
| K | 0.048 | 0.01 | 0.26 | 0.011 | 0.0036 | 0.0049 | 0.041 | 0.091 | 0.0004 | Ca: 0.01, | 0.062 | 0.00026 | 0.00143 | ◯ | Working |
| | | | | | | | | | | Mg: 0.02 | | | | | Example |
| L | 0.032 | 0.03 | 0.31 | 0.010 | 0.0028 | 0.0037 | 0.042 | 0.085 | 0.0012 | — | 0.057 | 0.00031 | 0.00142 | ◯ | Working |
| | | | | | | | | | | | | | | | Example |
| M | 0.026 | 0.02 | 0.54 | 0.011 | 0.0027 | 0.0036 | 0.040 | 0.084 | — | — | 0.056 | 0.00054 | 0.00141 | ◯ | Working |
| | | | | | | | | | | | | | | | Example |
| N | 0.031 | 0.02 | 0.29 | 0.012 | 0.0013 | 0.0038 | 0.051 | 0.089 | 0.0006 | Sn: 0.01, | 0.055 | 0.00029 | 0.00154 | ◯ | Working |
| | | | | | | | | | | Pb: 0.01 | | | | | Example |
| O | 0.031 | 0.01 | 0.31 | 0.012 | 0.0027 | 0.0031 | 0.052 | 0.097 | 0.0007 | — | 0.055 | 0.00031 | 0.00172 | ◯ | Working |
| | | | | | | | | | | | | | | | Example |
| P | 0.029 | 0.01 | 0.48 | 0.011 | 0.0031 | 0.0039 | 0.046 | 0.087 | — | — | 0.058 | 0.00048 | 0.00144 | ◯ | Working |
| | | | | | | | | | | | | | | | Example |
| Q | 0.024 | 0.01 | 0.28 | 0.010 | 0.0032 | 0.0038 | 0.043 | 0.083 | 0.0009 | Co: 0.01 | 0.058 | 0.00028 | 0.00136 | ◯ | Working |
| | | | | | | | | | | | | | | | Example |
| R | 0.023 | 0.02 | 0.33 | 0.012 | 0.0030 | 0.0037 | 0.042 | 0.078 | 0.0004 | Nb: 0.02, | 0.057 | 0.00033 | 0.00127 | ◯ | Working |
| | | | | | | | | | | Ta: 0.01 | | | | | Example |
| S | 0.026 | 0.02 | 0.53 | 0.011 | 0.0029 | 0.0042 | 0.048 | 0.089 | — | — | 0.059 | 0.00053 | 0.00146 | ◯ | Working |
| | | | | | | | | | | | | | | | Example |
| T | 0.031 | 0.01 | 0.62 | 0.011 | 0.0028 | 0.0037 | 0.039 | 0.082 | — | As: 0.01, | 0.057 | 0.00062 | 0.00136 | ◯ | Working |
| | | | | | | | | | | Cr: 0.02 | | | | | Example |
| U | 0.003 | 0.01 | 0.28 | 0.010 | 0.0027 | 0.0036 | 0.049 | 0.073 | — | — | 0.056 | 0.00028 | 0.00118 | X | Comparative |
| | | | | | | | | | | | | | | | Example |
| V | 0.029 | 0.01 | 0.51 | 0.010 | 0.0027 | 0.0035 | 0.048 | 0.041 | — | — | 0.056 | 0.00051 | 0.00052 | ◯ | Comparative |
| | | | | | | | | | | | | | | | Example |
| W | 0.004 | 0.02 | 0.48 | 0.012 | 0.0025 | 0.0034 | 0.005 | 0.042 | 0.0007 | Cu: 0.01 | 0.055 | 0.00048 | 0.00055 | X | Comparative |
| | | | | | | | | | | | | | | | Example |
| X | 0.031 | 0.02 | 2.01 | 0.012 | 0.0029 | 0.0040 | 0.042 | 0.086 | — | — | 0.058 | 0.00201 | 0.00142 | ◯ | Comparative |
| | | | | | | | | | | | | | | | Example |
| Y | 0.078 | 0.02 | 0.37 | 0.011 | 0.0030 | 0.0041 | 0.045 | 0.097 | — | Mg: 0.01, | 0.059 | 0.00037 | 0.00163 | ◯ | Comparative |
| | | | | | | | | | | Nb: 0.01 | | | | | Example |
| Z | 0.067 | 0.02 | 0.30 | 0.011 | 0.0037 | 0.0039 | 0.048 | 0.095 | 0.0005 | — | 0.059 | 0.00030 | 0.00158 | ◯ | Comparative |
| | | | | | | | | | | | | | | | Example |
| ZA | 0.024 | 0.01 | 0.46 | 0.011 | 0.0031 | 0.0042 | 0.051 | 0.131 | 0.0007 | — | 0.059 | 0.00046 | 0.00233 | X | Comparative |
| | | | | | | | | | | | | | | | Example |
| ZB | 0.058 | 0.01 | 0.47 | 0.013 | 0.0025 | 0.0031 | 0.045 | 0.110 | — | — | 0.054 | 0.00047 | 0.00199 | ◯ | Comparative |
| | | | | | | | | | | | | | | | Example |
| ZC | 0.027 | 0.02 | 0.34 | 0.010 | 0.0028 | 0.0041 | 0.046 | 0.069 | 0.0003 | — | 0.058 | 0.00034 | 0.00106 | ◯ | Comparative |
| | | | | | | | | | | | | | | | Example |

Formula (1): 0.04 + (N/14 × 48 + S/32 × 48)
Formula (2): 0.001 × Mn (mass %)
Formula (4): Ti/48 − N/14 − S/32
*A circle indicates that Formula (4) (C/12 > Ti/48 − N/14 − S/32) was satisfied.
A cross indicates that Formula (4) was not satisfied.

TABLE 5

| | | Manufacturing conditions | | | |
|---|---|---|---|---|---|
| | | for hot-rolled steel sheet | | | |
| | | Finish- | Average | Coiling | |
| | | rolling | cooling | tem- | |
| | Hot- | tempera- | tempera- | pera- | |
| Steel | rolling | ture | ture | ture | |
| No. | No. | (° C.) | (° C./s) | (° C.) | Note |
| H | 12 | 915 | 25 | 685 | Working Example |
| | 13 | 920 | 30 | 655 | Working Example |
| | 14 | 835 | 30 | 645 | Comparative Example |
| I | 15 | 916 | 25 | 690 | Working Example |
| | 16 | 906 | 40 | 700 | Working Example |
| | 17 | 912 | 5 | 695 | Comparative Example |
| J | 18 | 926 | 20 | 645 | Working Example |
| | 19 | 909 | 25 | 540 | Comparative Example |
| | 20 | 911 | 30 | 810 | Comparative Example |
| K | 21 | 912 | 25 | 625 | Working Example |
| | 22 | 921 | 40 | 730 | Working Example |
| | 23 | 907 | 5 | 535 | Comparative Example |
| L | 24 | 922 | 25 | 730 | Working Example |
| M | 25 | 908 | 30 | 745 | Working Example |
| N | 26 | 928 | 30 | 685 | Working Example |
| O | 27 | 899 | 30 | 630 | Working Example |
| P | 28 | 914 | 25 | 610 | Working Example |
| Q | 29 | 908 | 30 | 745 | Working Example |
| R | 30 | 928 | 30 | 685 | Working Example |
| S | 31 | 899 | 30 | 630 | Working Example |
| T | 32 | 914 | 25 | 610 | Working Example |
| U | 33 | 906 | 20 | 625 | Comparative Example |
| V | 34 | 912 | 25 | 725 | Comparative Example |
| W | 35 | 925 | 30 | 710 | Comparative Example |
| X | 36 | 931 | 30 | 650 | Comparative Example |
| Y | 37 | 912 | 25 | 625 | Comparative Example |
| Z | 38 | 913 | 20 | 640 | Comparative Example |
| ZA | 39 | 916 | 25 | 630 | Comparative Example |
| ZB | 40 | 907 | 30 | 650 | Comparative Example |
| ZC | 41 | 909 | 30 | 611 | Comparative Example |

A test specimen was sampled from the hot-rolled steel sheet and, in the same manner as in Example 1, was subjected to the structure observation, the tensile test, and the hole expanding test to determine the area ratio of a ferrite phase, the average grain size and volume ratio of Ti-containing fine carbide, the atomic ratio of C to Ti in the fine carbide, tensile strength, and the hole expanding ratio (stretch flange formability).

Table 6 shows the results.

TABLE 6

| | | | | | | | Mechanical | | |
|---|---|---|---|---|---|---|---|---|---|
| | | Structure of hot-rolled steel sheet | | | | | characteristics of | | |
| | | | | Ti-containing fine carbide | | | hot-rolled steel sheet | | |
| | Hot- | | Area ratio of | Average | | | Tensile | Hole | |
| Steel | rolling | | ferrite phase | grain size | Volume | | strength | expanding | |
| No. | No. | Type *1 | (%) *2 | (nm) | ratio *3 | C/Ti *4 | TS (MPa) | ratio λ (%) | Note |
| H | 12 | F | 100 | 5 | 0.0029 | 1.53 | 608 | 123 | Working Example |
| | 13 | F | 100 | 5 | 0.0028 | 1.34 | 611 | 115 | Working Example |
| | 14 | F + B | 92 | 4 | 0.0021 | 1.12 | 608 | 88 | Comparative |
| | | | | | | | | | Example |
| I | 15 | F + P | 99 | 4 | 0.0022 | 1.65 | 614 | 125 | Working Example |
| | 16 | F | 100 | 5 | 0.0020 | 1.45 | 615 | 135 | Working Example |
| | 17 | F + B | 99 | 19 | 0.0018 | 1.22 | 479 | 143 | Comparative |
| | | | | | | | | | Example |
| J | 18 | F | 100 | 4 | 0.0026 | 1.11 | 618 | 121 | Working Example |
| | 19 | F + B | 93 | 4 | 0.0004 | 1.24 | 523 | 134 | Comparative |
| | | | | | | | | | Example |
| | 20 | F + B | 98 | 14 | 0.0027 | 1.22 | 541 | 118 | Comparative |
| | | | | | | | | | Example |
| K | 21 | F | 100 | 8 | 0.0025 | 1.65 | 597 | 128 | Working Example |
| | 22 | F | 100 | 5 | 0.0023 | 1.55 | 618 | 123 | Working Example |
| | 23 | F | 100 | 16 | 0.0024 | 1.43 | 512 | 131 | Comparative |
| | | | | | | | | | Example |
| L | 24 | F | 100 | 4 | 0.0029 | 1.24 | 622 | 114 | Working Example |
| M | 25 | F + P | 95 | 4 | 0.0024 | 1.11 | 601 | 128 | Working Example |
| N | 26 | F + B | 97 | 3 | 0.0025 | 1.13 | 613 | 131 | Working Example |
| O | 27 | F + B | 98 | 5 | 0.0026 | 1.19 | 621 | 124 | Working Example |
| P | 28 | F | 100 | 4 | 0.0018 | 1.24 | 625 | 111 | Working Example |
| Q | 29 | F | 100 | 5 | 0.0019 | 1.04 | 596 | 124 | Working Example |
| R | 30 | F | 100 | 4 | 0.0017 | 1.52 | 605 | 131 | Working Example |
| S | 31 | F | 100 | 5 | 0.0018 | 1.21 | 619 | 122 | Working Example |
| T | 32 | F | 100 | 5 | 0.0020 | 1.33 | 613 | 126 | Working Example |
| U | 33 | F | 100 | 11 | 0.0001 | 0.07 | 412 | 135 | Comparative |
| | | | | | | | | | Example |
| V | 34 | F + P | 99 | 4 | 0.0006 | 2.68 | 430 | 132 | Comparative |
| | | | | | | | | | Example |
| W | 35 | F + B | 99 | 5 | 0.0005 | 0.91 | 492 | 131 | Comparative |
| | | | | | | | | | Example |
| X | 36 | F | 100 | 5 | 0.0027 | 1.23 | 624 | 84 | Comparative |
| | | | | | | | | | Example |
| Y | 37 | F + P | 98 | 4 | 0.0051 | 1.89 | 734 | 76 | Comparative |
| | | | | | | | | | Example |
| Z | 38 | F | 100 | 5 | 0.0048 | 1.76 | 712 | 75 | Comparative |
| | | | | | | | | | Example |
| ZA | 39 | F | 100 | 17 | 0.0012 | 0.84 | 512 | 124 | Comparative |
| | | | | | | | | | Example |
| ZB | 40 | F | 100 | 5 | 0.0056 | 1.65 | 753 | 76 | Comparative |
| | | | | | | | | | Example |
| ZC | 41 | F + P | 97 | 12 | 0.0008 | 1.15 | 479 | 124 | Comparative |
| | | | | | | | | | Example |

*1: F denotes ferrite. P denotes pearlite. B denotes bainite.
*2: Area ratio of ferrite phase to the entire structure (%)
*3: Volume ratio of Ti-containing fine carbide to the entire structure
*4: Atomic ratio of C to Ti in Ti-containing fine carbide

The Working Examples are hot-rolled steel sheets having high-strength, that is, tensile strength TS of 590 MPa or more, and excellent stretch flange formability, that is, a hole expanding ratio λ of 100% or more. The Comparative Examples outside our range do not have the predetermined high strength or hole expanding ratio λ.

1. A high-strength hot-rolled steel sheet having excellent formability, comprising:
a composition comprising
C: 0.005% or more and 0.050% or less, Si: 0.2% or less,
Mn: 0.8% or less, P: 0.025% or less,
S: 0.01% or less, N: 0.01% or less,
Al: 0.06% or less, and Ti: 0.05% or more and 0.10% or less, on a mass percent basis, such that S, N, and Ti satisfy Formula (1), the remainder being Fe and incidental impurities; a matrix in which a ferrite phase constitutes 95% by area or more of the entire structure; and a structure in which Ti-containing fine carbide having an average grain size of less than 10 nm is dispersedly precipitated, and volume ratio of the fine carbide to the entire structure is 0.0007 or more, wherein the high-strength hot-rolled steel sheet has a tensile strength of 590 MPa or more:
Ti≧0.04+(N/14×48+S/32×48) (1)
wherein S, N, and Ti denote their respective contents (% by mass).

2. The steel sheet according to claim 1, further comprising B: 0.0003% or more and 0.0035% or less on a mass percent basis to satisfy Formula (2):
B≧0.001×Mn (2)
wherein Mn and B denote their respective contents (% by mass).

3. The steel sheet according to claim 1, wherein the composition satisfies Formula (4):
C/12>Ti/48−N/14−S/32 (4)
wherein C, S, N, and Ti denote their respective contents (% by mass).

4. The steel sheet according to claim 1, wherein atomic ratio of C to Ti in the fine carbide satisfies Formula (3):
C/Ti>1.0 (3)
wherein C/Ti denotes the atomic ratio of C to Ti in the fine carbide.

5. The steel sheet according to claim 1, further comprising at least one of Cu, Sn, Ni, Ca, Mg, Co, As, Cr, W, Nb, Pb, and Ta, which in total constitutes 0.1% or less of the composition on a mass percent basis.

6. The steel sheet according to claim 1, farther comprising a plating film on the surface thereof.

7. A method of manufacturing a high-strength hot-rolled steel sheet having a tensile strength of 590 MPa or more and excellent formability, comprising:
hot roiling steel, the hot rolling involving rough rolling and finish rolling; and then cooling and coiling the steel to manufacture a hot-rolled steel sheet,
wherein the steel has a composition comprising
C: 0.005% or more and 0.050% or less, Si: 0.2% or less,
Mn: 0.8% or less, P: 0.025% or less,
S: 0.01% or less, N: 0.01% or less,
Al: 0.06% or less, and Ti; 0.05% or more and 0.10% or less, on a mass percent basis, such that 5, N, and Ti satisfy Formula (1), the remainder being Fe and incidental impurities, wherein
finish-rolling temperature is 880° C. or more, average cooling rate is 10° C./s or more, and coiling temperature is 550° C. or more and less than 800° C.:
Ti≧0.04++(N/14×48+S/32×48) (1)
wherein S, N, and Ti denote their respective contents (% by mass).

8. The method according to claim 7, wherein the composition further comprises B: 0.0003% or more and 0.0035% or less on a mass percent basis to satisfy Formula (2):
B≧0.001×Mn (2)
wherein Mn and H denote their respective contents (% by mass).

9. The method according to claim 7, wherein the composition satisfies Formula (4):
C/12>Ti/48−N/14−S/32 (4)
wherein C, S, N, and Ti denote their respective contents (% by mass).

10. The method according to claim 7, wherein the composition further comprises at least one of Cu, Sn, Ni, Ca, Mg, Co, As, Cr, W, Nb, Pb, and Ta, which in total constitutes 0.1% or less of the composition on a mass percent basis.

11. The steel sheet according to claim 2, wherein the composition satisfies Formula (4):
C/12>Ti/48−N/14−S/32 (4)
wherein C, S, N, and Ti denote their respective contents (% by mass).

12. The steel sheet according to claim 2, wherein atomic ratio of C to Ti in the fine carbide satisfies Formula (3):
C/Ti>1.0 (3)
wherein C/Ti denotes the atomic ratio of C to Ti in the fine carbide.

13. The steel sheet according to claim 3, wherein atomic ratio of C to Ti in the line carbide satisfies Formula (3):
C/Ti>1.0 (3)
wherein C/Ti denotes the atomic ratio of C to Ti in the fine carbide.

14. The steel sheet according to claim 2, further comprising at least one of Cu, Sn, Ni, Ca, Mg, Co, As, Cr, W, Nb, Pb, and Ta, which in total constitutes 0.1% or less of the composition on a mass percent basis.

15. The steel sheet according to claim 3, further comprising at least one of Cu, Sn, Ni, Ca, Mg, Co, As, Cr, W, Nb, Pb, and Ta, which in total constitutes 0.1% or less of the composition on a mass percent basis.

16. The steel sheet according to claim 4, farther comprising at least one of Cu, Sn, Ni, Ca, Mg, Co, As, Cr, W, Nb, Pb, and Ta, which in total constitutes 0.1% or less of the composition on a mass percent basis.

17. The method according to claim 8, wherein the composition satisfies Formula (4):
C/12>Ti/48−N/14−S/32 (4)
wherein C, S, N, and Ti denote their respective contents (% by mass).

18. The method according to claim 8, wherein the composition farther comprises at least one of Cu, Sn, Ni, Ca, Mg, Co, As, Cr, W, Nb, Pb, and Ta, which in total constitutes 0.1% or less of the composition on a mass percent basis.

19. The method according to claim 9, wherein the composition further comprises at least one of Cu, Sri, Ni, Ca, Ma, Co, As, Cr, W, Nb, Pb, and Ta, which in total constitutes 0.1% or less of the composition on a mass percent basis.
